(19) United States
(12) Patent Application Publication
(10) Pub. No.: US 2013/0048082 A1
(43) Pub. Date: Feb. 28, 2013

(54) SYSTEM, METHOD AND APPARATUS FOR REAL TIME CONTROL OF RAPID ALTERNATING PROCESSES (RAP)

(71) Applicants: Mirzafer Abatchev, Fremont, CA (US); Bradley Howard, Fremont, CA (US); Armen Kirakosian, Fremont, CA (US)

(72) Inventors: Mirzafer Abatchev, Fremont, CA (US); Bradley Howard, Fremont, CA (US); Armen Kirakosian, Fremont, CA (US)

(21) Appl. No.: 13/215,159

(22) Filed: Aug. 22, 2011

(51) Int. Cl. F17D 3/00

(52) U.S. Cl. 137/1; 137/551

(57) ABSTRACT

A rapid alternating process system and method of operating a rapid alternating process system includes a rapid alternating process chamber, a plurality of process gas sources coupled to the rapid alternating process chamber, wherein each one of the plurality of process gas sources includes a corresponding process gas source flow controller, a bias signal source coupled to the rapid alternating process chamber, a process gas detector coupled to the rapid alternating process chamber, a rapid alternating process chamber controller coupled to the rapid alternating process chamber, the bias signal source, the process gas detector and the plurality of process gas sources, the rapid alternating process chamber controller including logic for initiating a first rapid alternating process phase including: logic for inputting a first process gas into a rapid alternating process chamber, logic for detecting the first process gas in the rapid alternating process chamber, and logic for applying a corresponding first phase bias signal to the rapid alternating process chamber after the first process gas is detected in the rapid alternating process chamber.

### BACKGROUND

The present invention relates generally to semiconductor processes and processing chambers, and more particularly, to systems methods and apparatus for controlling rapid alternating processes (RAP) and RAP chambers.

Rapid alternating processes (RAP) typically include placing a work piece in the chamber and then applying an alternating, repetitive cycle, of two or more processes (e.g., phases) to the work piece. Typically each process/phase will have multiple, respective set points for gas pressure, gas mixture concentrations, gas flow rates, bias voltage, frequency, temperature of the chamber, temperature of the work piece, processing signal (e.g., RF, microwave, etc.) and many other process set points. Thus, a first phase cannot effectively begin until the various process set points the first phase are achieved. Further, when switching from the first phase to a second, subsequent phase, the various process set points the second phase must be achieved before the second phase can most effectively begin.

The process phase change time interval is the time delay between ending the first phase and beginning the second phase. During the process phase change time process parameters changes and it takes different time for each parameter to achieve set point for the specific process phase. Thus this process phase change time interval reduces the operation time and therefore the effective throughput of the RAP chamber.

Typically, the process phase change time interval is primarily determined by the set points for gas mixture concentration and gas pressure. The gas mixture concentration and gas pressure are typically determined by the mass flow controllers (MFCs) that control the delivery of the various gases to the RAP chamber.

Typically, the set point is determined by an estimated time for gas arrival in the RAP chamber. By way of example, typically a 200-700 msec delivery delay is required for gas to arrive in the RAP chamber after the controller “instructs” the mass flow controller to deliver the gas. This delivery delay is due, at least in part, to delays in mass flow controller response, the gas pressure and the length of process piping between the mass flow controller and the RAP chamber. Other delays can also add to the delivery delay.

Unfortunately, in RAP the cycle time is desired to be as short as possible to attain the best aspect ratio (e.g., depth/width), where a best aspect ratio is typically a consistent width and depth for a given process time. The RAP cycle times are approaching less than 1 second per RAP cycle. Typically 100-500 or more RAP cycles are used for a single RAP process. Each RAP cycle typically includes an etching process (or phase) and a deposition process (or phase). Additional processes can also be included in each RAP cycle. Therefore, the gas arrival time must be estimated and the biasing and other parameters set or initiated at the estimated time.

As a result the optimum process parameters for each phase are typically not achieved and are therefore not as repeatable or as consistent as desired. Further, the less than optimum timing of both the gas concentration arrival and the application of bias voltage results in a less than optimum and less predictable etch rate and/or deposition rate for the corresponding phase of each RAP cycle. The result is inconsistent processing in each RAP cycle. In view of the foregoing, there is a need for an improved RAP cycle control.

### SUMMARY

Broadly speaking, the present invention fills these needs by providing a system, method and apparatus for an improved RAP cycle control. It should be appreciated that the present invention can be implemented in numerous ways, including as a process, an apparatus, a system, computer readable media, or a device. Several inventive embodiments of the present invention are described below.

One embodiment provides a rapid alternating process method including initiating a first rapid alternating process phase including inputting a first process gas into a rapid alternating process chamber, detecting the first process gas in the rapid alternating process chamber and applying a corresponding first phase bias signal to the rapid alternating process chamber after the first process gas is detected in the rapid alternating process chamber.

Detecting the first process gas in the rapid alternating process chamber can also include detecting a corresponding concentration of the first process gas in the rapid alternating process chamber. Detecting the first process gas in the rapid alternating process chamber can include detecting a corresponding first product of disassociation of the first process gas. Detecting the first process gas in the rapid alternating process chamber can also include detecting a corresponding first optical emissions spectrum.

Detecting the corresponding first optical emissions spectrum can include determining a value of the detected corresponding first optical emissions spectrum. The corresponding first phase bias signal can be applied to the rapid alternating process chamber when the determined value of the detected corresponding first optical emissions spectrum exceeds a preselected value.

The determined value of the corresponding first optical emissions spectrum can include a derivative of the detected corresponding first optical emissions spectrum relative to time.

The method can also include initiating a second rapid alternating process phase including inputting a process second gas into the rapid alternating process chamber, detecting the second process gas in the rapid alternating process chamber and applying a corresponding second phase bias signal to the rapid alternating process chamber after the second process gas is detected in the rapid alternating process chamber.

The method can also include determining if additional rapid alternating process cycles are required including ending the method if additional rapid alternating process cycles are not required and initiating the first rapid alternating process phase if additional rapid alternating process cycles are required. Applying the corresponding first phase bias signal to the rapid alternating process chamber after the first process gas is detected in the rapid alternating process chamber can include applying at least one of a corresponding RF signal, voltage, frequency, waveform, modulation, and power of the first phase bias signal applied to the substrate or applying at least one of a corresponding RF signal, voltage, frequency, waveform, modulation, and power of the first plasma source power.

Another embodiment provides a rapid alternating process system including a rapid alternating process chamber, a plurality of process gas sources coupled to the rapid alternating process chamber, wherein each one of the plurality of process gas sources includes a corresponding process gas source flow controller, a bias signal source coupled to the rapid alternating process chamber, a process gas detector coupled to the rapid alternating process chamber, a rapid alternating process chamber controller coupled to the rapid alternating process chamber, the bias signal source, the process gas detector and the plurality of process gas sources, the rapid alternating process chamber controller including logic for initiating a first rapid alternating process phase including: logic for inputting a first process gas into a rapid alternating process chamber, logic for detecting the first process gas in the rapid alternating process chamber, and logic for applying a corresponding first phase bias signal to the rapid alternating process chamber after the first process gas is detected in the rapid alternating process chamber.

The logic for detecting the first process gas in the rapid alternating process chamber can include logic for detecting a corresponding concentration of the first process gas in the rapid alternating process chamber. The logic for detecting the first process gas in the rapid alternating process chamber can include logic for detecting a corresponding first product of disassociation of the first process gas. The logic for detecting the first process gas in the rapid alternating process chamber can include logic for detecting a corresponding first optical emissions spectrum by the process gas detector.

The logic for detecting the corresponding first optical emissions spectrum can include logic for determining a value of the detected corresponding first optical emissions spectrum. The corresponding first phase bias signal can be applied to the rapid alternating process chamber when the determined value of the detected corresponding first optical emissions spectrum exceeds a preselected value.

The logic for determined value of the corresponding first optical emissions spectrum can include logic for determining a derivative of the detected corresponding first optical emissions spectrum relative to time. The rapid alternating process chamber controller can further include logic for initiating a second rapid alternating process phase including: logic for inputting a process second gas into the rapid alternating process chamber logic for detecting the second process gas in the rapid alternating process chamber and logic for applying a corresponding second phase bias signal to the rapid alternating process chamber after the second process gas is detected in the rapid alternating process chamber.

The rapid alternating process chamber controller can also include logic for determining if additional rapid alternating process cycles are required including: logic for ending the method if additional rapid alternating process cycles are not required and logic for initiating the first rapid alternating process phase if additional rapid alternating process cycles are required.

Yet another embodiment provides a rapid alternating process system including a rapid alternating process chamber a plurality of process gas sources coupled to the rapid alternating process chamber, wherein each one of the plurality of process gas sources includes a corresponding process gas source flow controller. A bias signal source is coupled to the rapid alternating process chamber. A process gas detector is coupled to the rapid alternating process chamber. A rapid alternating process chamber controller is coupled to the rapid alternating process chamber, the bias signal source, the process gas detector and the plurality of process gas sources. The rapid alternating process chamber controller including logic for initiating a first rapid alternating process phase including logic for inputting a first process gas into a rapid alternating process chamber logic for detecting the first process gas in the rapid alternating process chamber including logic for detecting a corresponding first optical emissions spectrum by the process gas detector including logic for determining a value of the detected corresponding first optical emissions spectrum including logic for determining a derivative of the detected corresponding first optical emissions spectrum relative to time, logic for applying a corresponding first phase bias signal to the rapid alternating process chamber after the first process gas is detected in the rapid alternating process chamber, logic for initiating a second rapid alternating process phase and logic for determining if additional rapid alternating process cycles are required.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 is a schematic of a RAP chamber system, in accordance with an embodiment of the invention.

FIGS. 2A-2C illustrate graphical representations of control schemes of typical mass flow controllers, in accordance with an embodiment of the present invention.

FIG. 2D is a flowchart diagram that illustrates the method and operations performed in advance the timing of control signals from the controller to the MFCs, in accordance with one embodiment of the present invention.

FIGS. 3A and 3B illustrate silicon etch rate, in accordance with an embodiment of the present invention.

FIG. 4 illustrates Si/PR selectivity, in accordance with an embodiment of the present invention.

FIGS. 5A and 5B show a variation of gas delivery time during etch/deposition phases, in accordance with an embodiment of the present invention.

FIG. 6 is a graphical representation of various aspects of an OES signal, in accordance with an embodiment of the present invention.

FIG. 7 is a flowchart diagram that illustrates the method and operations performed in using an OES spectrum to control bias voltage, in accordance with one embodiment of the present invention.

### DETAILED DESCRIPTION

Several exemplary embodiments for systems, methods and apparatus for an improved RAP cycle control will now be described. It will be apparent to those skilled in the art that the present invention may be practiced without some or all of the specific details set forth herein.

Rapid alternating process (RAP) is one approach to etch high aspect ratio features in silicon and other types of substrates and layers thereon. High aspect ratio features have a depth D that is equal to or greater than the width W.

The RAP technique includes rapid, repetitive, cycles where each cycle includes switching between two or more phases, all occurring in a single chamber. Each of an exemplary RAP cycle can include a passivating process or phase or an etch process or phase. The passivating phase can also include a deposition phase. Accurate control of the duration of each etching phase and each passivating phase develops reliably predictable, high aspect ratio etch process.

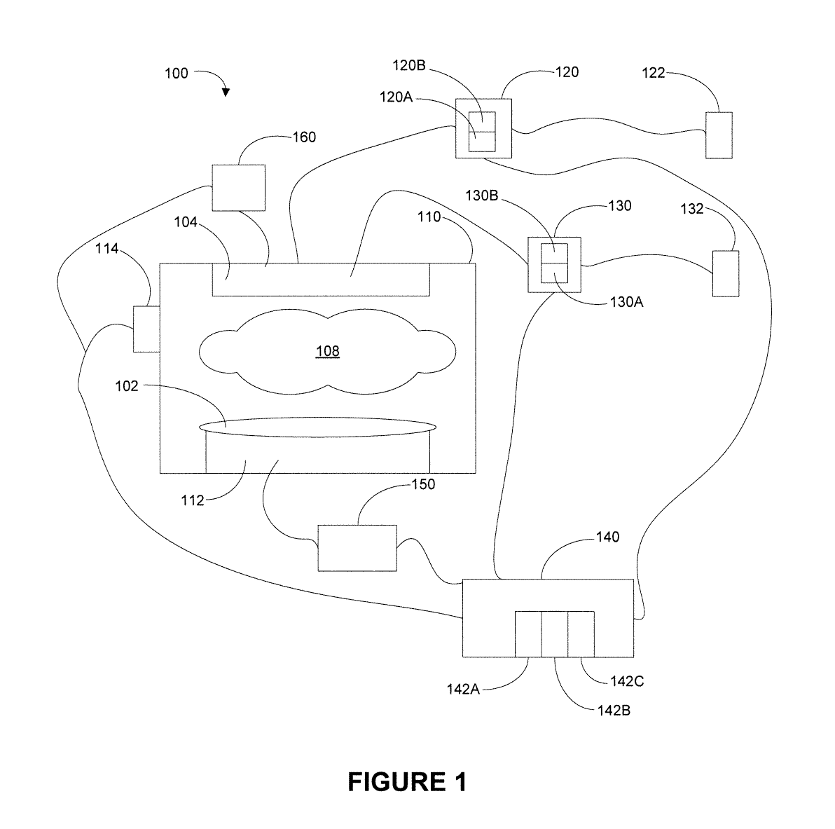

FIG. 1 is a schematic of a RAP chamber system 100 in accordance with an embodiment of the invention. The RAP chamber system 100 includes a RAP chamber 110. Within the RAP chamber 110 is a plasma 108 and a substrate 102 that is supported by a substrate support 112. A process gas detector 114 is coupled to the RAP chamber 110 in such a manner as to be able to monitor one or more aspects (e.g., spectrum, temperature, light intensity, etc.) of the plasma 108.

The RAP chamber 110 also includes a process gas dispenser or nozzle 104 (i.e., showerhead or other suitable type gas dispenser). A first mass flow controller (MFC) 120 and a second MFC 130 are coupled to the process gas dispenser or nozzle 104. The first MFC 120 is also coupled to a first gas source 122 to control the flow from the first gas source to the RAP chamber 110. The second MFC 130 is also coupled to a second gas source 132 to control the flow from the second gas source to the RAP chamber 110.

The RAP chamber system 100 also includes a RAP controller 140 and a bias voltage source 150. The controller 140 includes logic 142A, memory 142B, and operating system and software 142C among other components. The RAP controller 140 can include any standard computer (e.g., general purpose such as a personal computer, using any operation system) or a specialized computer (e.g., a specialized controller or a specially built computer using a customized operating system) The RAP controller 140 can include any of the components necessary for use including user interfaces (e.g., displays, keyboards, touch screens, etc.), communication interfaces (e.g., networking protocols and ports) memory systems including one or more of read only memory, random access memory, non-volatile memory (e.g., flash, hard drive, optical drive, network storage, remote storage, etc.) The RAP controller 140 can be coupled to a centralized, remote controller (not shown) that is capable of operating, monitoring, coordinating and controlling multiple systems from a central location. The RAP controller 140 is coupled to the bias source 150, the first MFC 120, the second MFC 130, the process gas detector 114, the plasma source power generator 160 and the RAP chamber 110.

The bias voltage source 150 can include one or more bias voltage and signal sources which can be coupled to the substrate support 112, the process gas dispenser or nozzle 104 or one or more walls of the RAP chamber 110. The bias voltage source 150 provides the RF signal, voltage, frequency, waveform, modulation, and power of the signal used to control the ion flux/energy from the plasma 108 to onto the substrate 102 surface. The plasma source power generator 160 provides the RF signal, voltage, frequency, waveform, modulation, and power of the signal used to generate the plasma 108. The plasma source power generator 160 coupled to the inductive coils which are separated from plasma by dielectric window in case of TCP (Transformer Coupled Plasma) etcher such as LAM Syndion. In case of dual frequency CCP (Capacitively Coupled Plasma) etcher the plasma source power generator 160 can be coupled to the top electrode 104 or the substrate support.

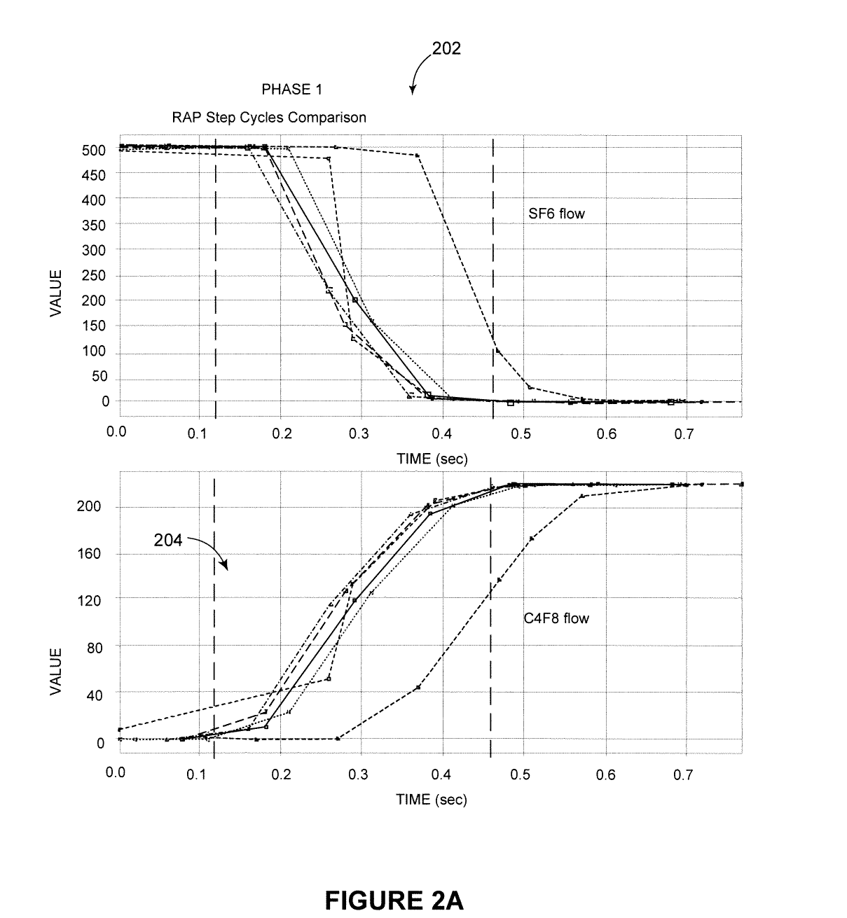

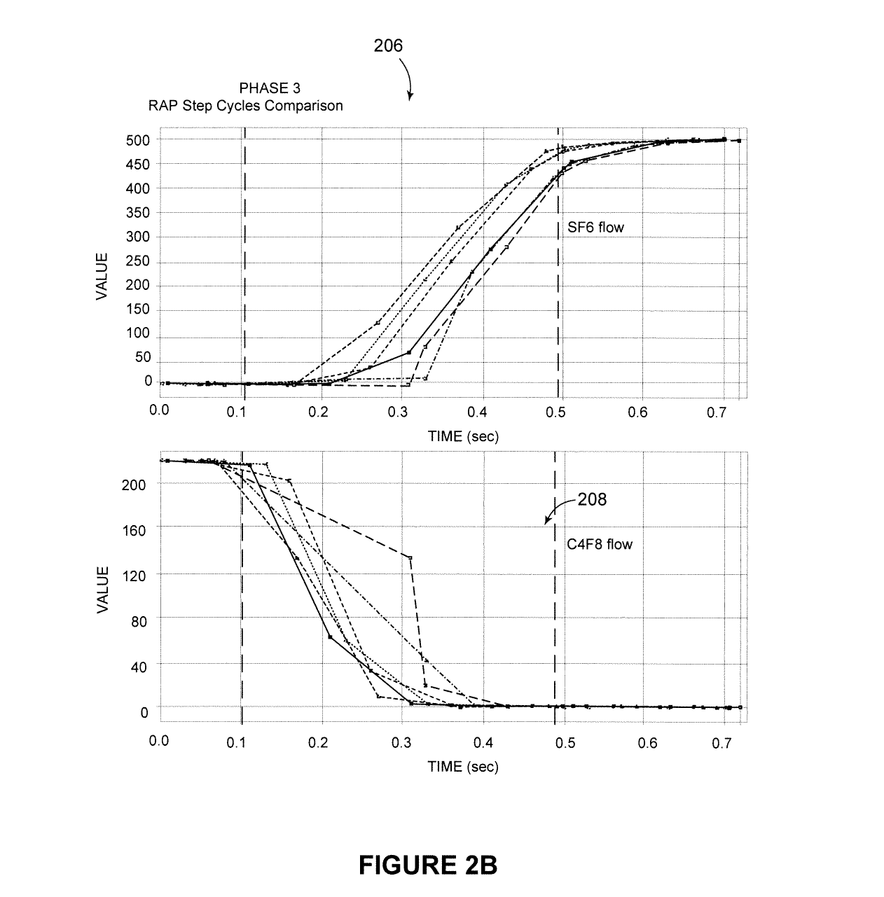

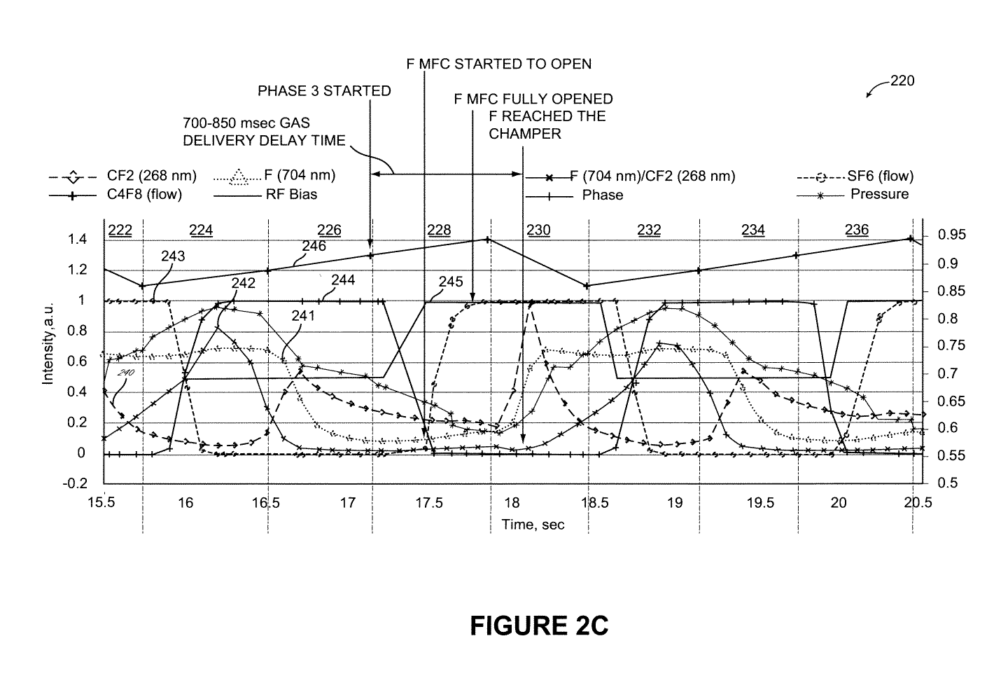

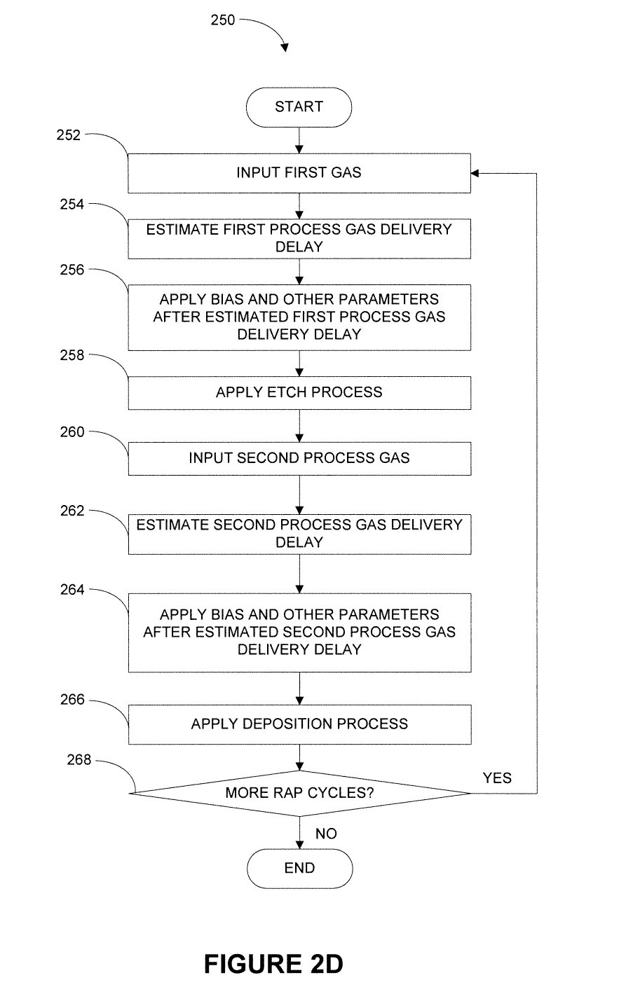

FIGS. 2A-2C illustrate graphical representations of control schemes of typical mass flow controllers, in accordance with an embodiment of the present invention. FIGS. 2A and 2B illustrate graphical representations of SF₆ 202, 206 and C₄F₈ 204, 208 MFC response times on a typical Syndion V2 MFC during the respective first phase and a second phase of a RAP cycle. Typical MFCs have a limited response time of between about 150 msec and about 300 msec (e.g, such as may be found on a Syndion V2 MFC).

FIG. 2C is a graphical representation of a RAP cycle 220. Multiple RAP phases 222-236 are illustrated. Graph 240 illustrates the presence of a product of dissociation (e.g., CF2) of a first process gas (e.g., C4F8) in the RAP chamber 110 as measured by a first intensity of an optical emission at a corresponding wavelength of light (e.g., CF2 has a corresponding wavelength 268 nm). Graph 241 illustrates the presence of a second process gas (e.g., SF6) in the RAP chamber 110 as measured by a second intensity of an optical emission at a corresponding wavelength of light (e.g., F has a corresponding wavelength 704 nm). Graph 242 illustrates a ratio of the second intensity and the first intensity in the RAP chamber 110.

Graph 243 illustrates the flow of a first process gas (e.g., C4F8) through the respective MFC as measured by the MFC. Graph 244 illustrates the flow of a second process gas (e.g., SF6) through the respective MFC as measured by the MFC.

Graph 245 illustrates the bias signal applied to the RAP chamber 110. Graph 246 illustrates the changes from one phase to a subsequent phase.

The first phase 222 of the RAP cycle 220 could be a passivation phase or a deposition phase. A delivery time delay between a preceding phase (e.g., phase 222) and a subsequent phase (e.g., phase 224) is the time required to deliver the respective process gas 122, 132 from the respective MFC 120, 130 to the RAP chamber 110. Using the Syndion V2 MFC as an example, the delivery time delay is between about 200 msec and about 350 msec.

Each of the MFCs 120, 130 includes a respective controller electrical circuit 120A, 130A that receives control signals from the controller 140 and produces the corresponding outputs to manipulate the respective valves 120B, 130B within the MFC. The respective controller electrical circuit 120A, 130A in each of the MFCs 120, 130 can also have a controller switch delay to a received control signal. The controller switch delay can introduce additional delay in delivering the gas 122, 132 from the respective MFC 120, 130. This controller switch delay can be up to about 200 msec on a Syndion V2, as shown in FIGS. 2A and 2B.

Referring now to the data point labeled “phase 3 started” this is the data point on graph 246 that indicates when the RAP controller 140 initiates a change from phase 226 preceding “phase 3” 228. As part of initiating the “phase 3” 228, the RAP controller 140 sends a command to the SF6 MFC. After a controller switch delay, the SF6 MFC starts to open at the respective data point. After a MFC response delay, the SF6MFC is fully opened at the respective data point. After a process gas delivery delay, the SF6 reaches the RAP chamber 100 at the respective data point. The total time delay from “phase 3 started” to when the SF6 reaches the RAP chamber 100 is between about 700 msec and about 850 msec. This between about 700 msec and about 850 msec variation causes inconsistent processing.

The duration of each etch and/or deposition phase of the RAP cycle is desired to be as short as possible and thus is comparable to or desirable to be even shorter than the total delay time caused by these three factors. As result two essential problems are presented. First, uncertainty of time when specific bias power/voltage should be applied for optimum results during each phase. This parameter is very important for some RAP cycles as shown in FIGS. 2A-2C.

Due to the limited response time of the MFCs 120, 130 and a known distance between MFCs 120, 130 and the RAP chamber 110, between about 700 msec and about 850 msec can be required to deliver gas into the chamber. This variable delay results in difficulty to accurately control the respective bias voltage for each phase of RAP cycle.

One approach to compensate for this total delay time is to advance the timing of control signals from the controller 140 to the MFCs 120, 130. As a result the operation of the MFCs are advanced in time. FIG. 2D is a flowchart diagram that illustrates the method and operations 250 performed in advance the timing of control signals from the controller 140 to the MFCs, in accordance with one embodiment of the present invention. The operations illustrated herein are by way of example, as it should be understood that some operations may have sub-operations and in other instances, certain operations described herein may not be included in the illustrated operations. With this in mind, the method and operations 250 will now be described.

In operation 252, a first gas is input to the RAP chamber 110 including sending a first instruction from the controller 140 to the first mass flow controller 120 to flow the first gas from the first gas source 122.

In an operation 254, a first gas delivery time is estimated based on previous iterations and/or test data. When the estimated first gas delivery time is reached, the corresponding first process parameter set points 272 (e.g., first bias voltage, first bias frequency and other first process parameters) for the corresponding first phase, are applied to the RAP chamber 110, in an operation 256.

In an operation 258, the corresponding phase (e.g., an etch phase) is applied to the substrate 102 in the RAP chamber 110. In operation 260, a second gas is input to the RAP chamber 110 including sending a second instruction from the controller 140 to the second mass flow controller 130 to flow the second gas from the second gas source 132.

In an operation 262, a second gas delivery time is estimated based on previous iterations and/or test data. When the estimated second gas delivery time is reached, the corresponding second process parameter set points 282 (e.g., second bias voltage, second bias frequency and other second process parameters) for the corresponding second phase, are applied to the RAP chamber 110, in an operation 264.

In an operation 266, the corresponding second phase (e.g., a deposition or passivation phase) is applied to the substrate 102 in the RAP chamber 110.

In an operation 268, an inquiry is made to determine if additional RAP cycles are necessary on the substrate 102 in the RAP chamber 110. If additional RAP cycles are necessary on the substrate 102 in the RAP chamber 110, the method operations continue in operation 252 as described above. The method operations can end if additional RAP cycles are not necessary on the substrate 102.

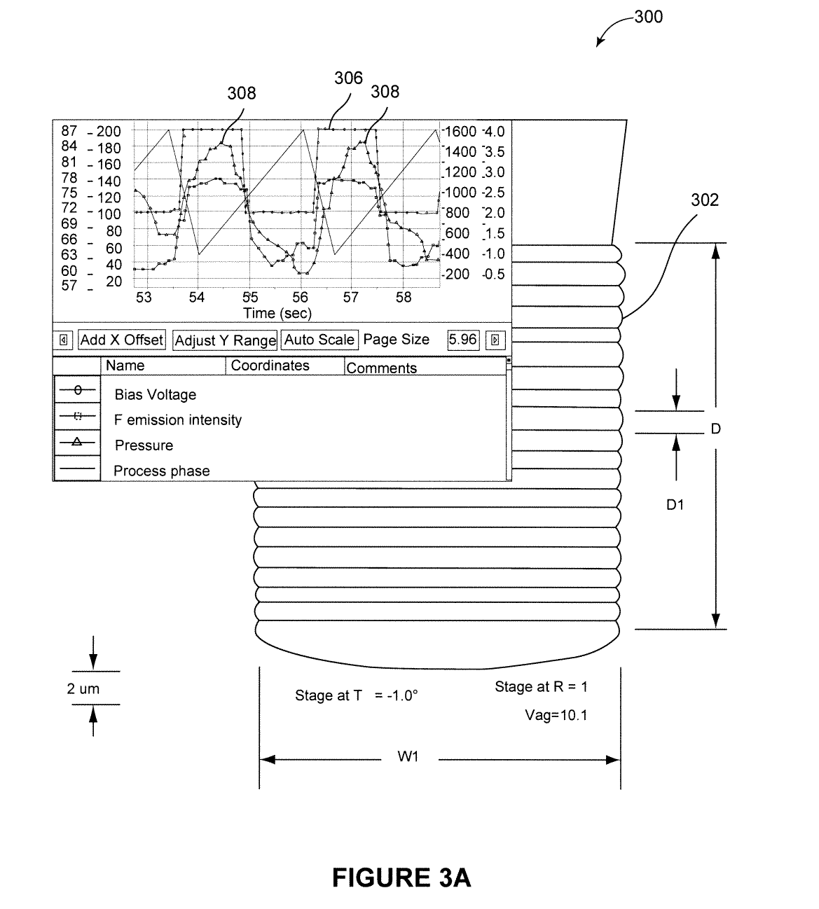

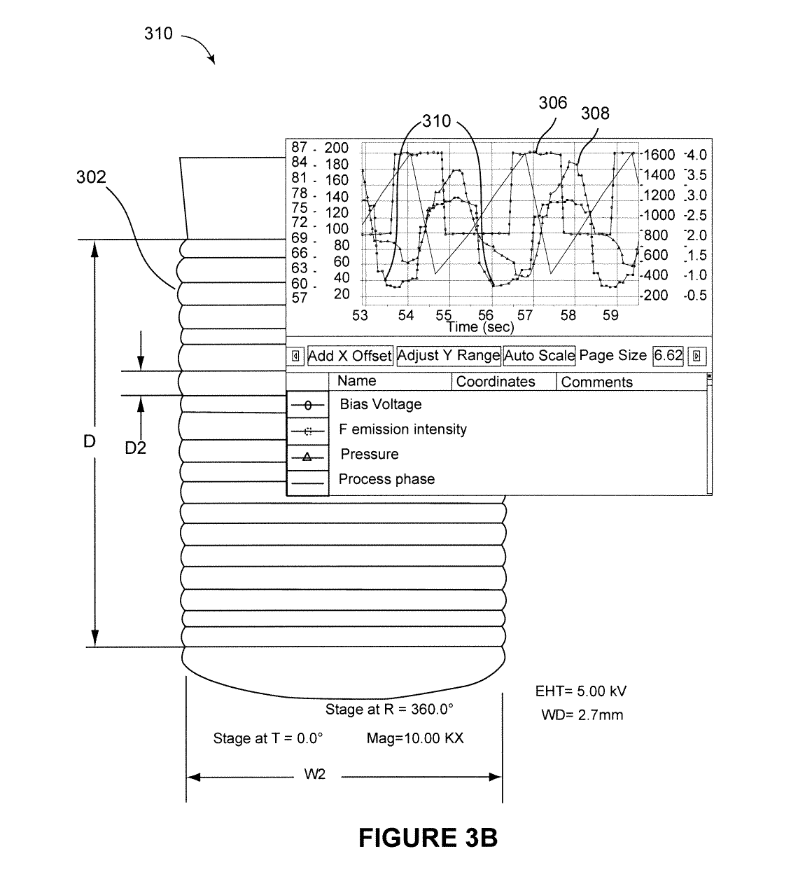

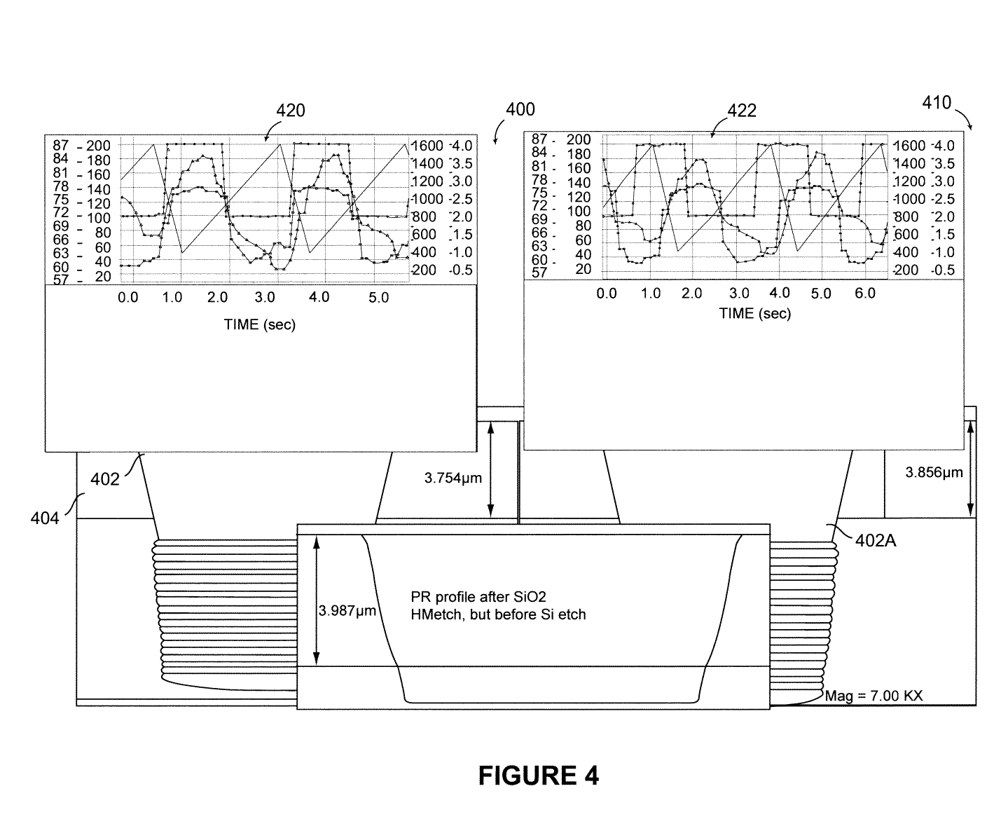

FIGS. 3A and 3B illustrate silicon etch rate 300, 310, in accordance with an embodiment of the present invention. FIG. 4 illustrates Si/PR selectivity 400, 410, in accordance with an embodiment of the present invention. Each of FIGS. 3 and 4 illustrate each phase is sensitive to bias voltage/power timing during each phase of the RAP cycle.

As shown in FIG. 3A, an etch bias voltage 306 was applied, as desired, mostly during the etch phase of the process gas concentration 308. The resulting consistent phase depth D1 and width W of each etch phase is shown in the consistent width W1 and phase depth D1 of the scallops 302.

As shown in FIG. 3B, the etch bias voltage 306 was applied mostly during the passivation phase 318 of the process gas concentration. The resulting inconsistent phase depth D2 and width of each etch phase is shown in the inconsistent width W2 and phase depth D2 of the scallops 312.

As shown in graph 400 of FIG. 4, the etch bias voltage is applied, as desired, mostly during the etch phase and thus the resulting etch profile of the via 402 through the photoresist 404 is straight and substantially perpendicular relative to the top surface 406 of the photoresist.

As shown in graph 410 of FIG. 4, the etch bias voltage is applied, as less desired, mostly during the passivation phase and thus the resulting etch profile of the via 402A through the photoresist 404 is less straight and has more angled sides and is less perpendicular relative to the top surface 406 of the photoresist.

Silicon (Si) etch rate is dependent on the time when bias voltage is applied during each RAP etch phase. As shown in FIG. 4, photoresist (PR) etch rate can vary as much as 50% or more. As a result a Si/PR etch selectivity can be fall in a wide range of values and thus cause a corresponding variation in results.

The inconsistencies are further exacerbated when the timing for the start of each RAP phase is advanced during wafer processing to attempt to minimize effects related with aspect ratio change during the etch process.

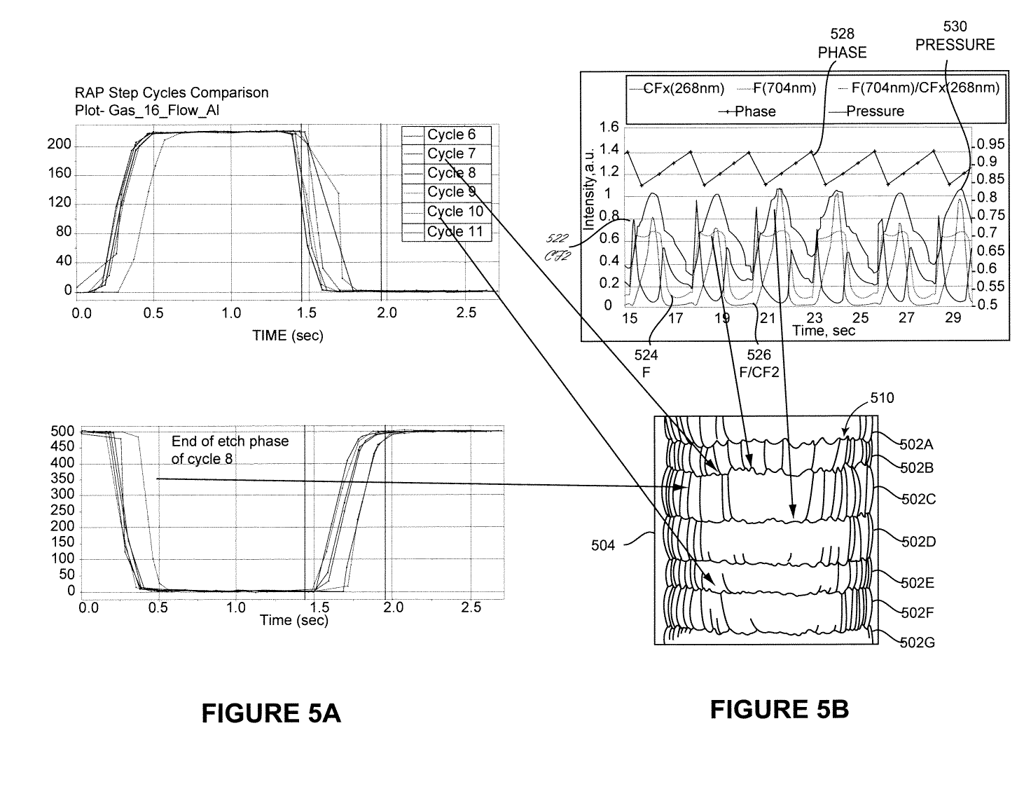

FIGS. 5A and 5B show a variation of gas delivery time during etch/deposition phases, in accordance with an embodiment of the present invention. [F]/[CF2] of an optical emissions spectrum (OES) signal during the etch phase, as shown in FIG. 5A, and a scanning electron microscope cross-section of the resulting via 510, as shown in FIG. 5B, illustrate a very accurate correlation. Variations of gas delivery time results in a considerable variation of depth of “scallops” 502A-G. Ideally, the scallops 502A-G should all be substantially the same depth into the substrate 504. An uncertainty in or inconsistency of time shift/delay of bias voltage application timing in each of the RAP phases caused by delay of gas delivery causes vertical striation of the sides of the via 510. The ratio of OES intensity [F]/[CF2] during etch process (e.g., when CF2 still has a decaying tail after a previous deposition phase) integrally reflects the effect of duration for both etch processes and passivation processes.

FIG. 5B also includes a graphical representation of a RAP cycle 520. Multiple RAP phases are illustrated. Graph 522 illustrates the presence of a product of dissociation (CF2) of a first process gas (e.g., C4F8) in the RAP chamber 110 as measured by a first intensity of an optical emission at a corresponding wavelength of light (e.g., CF2 has a corresponding wavelength 268 nm). Graph 524 illustrates the presence of a product of dissociation (e.g., F) of a second process gas (e.g., SF6) in the RAP chamber 110 as measured by a second intensity of an optical emission at a corresponding wavelength of light (e.g., F has a corresponding wavelength 704 nm). Graph 526 illustrates a ratio of the second intensity and the first intensity in the RAP chamber 110. Graph 522 illustrates the phases. Graph 524 illustrates the pressure in the RAP chamber 100.

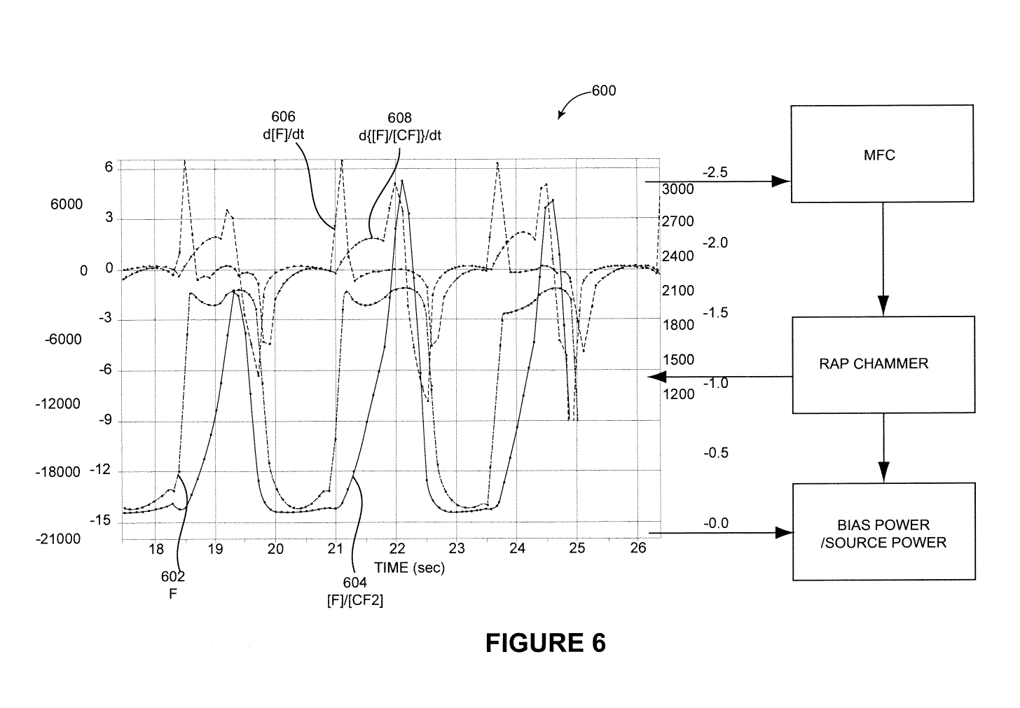

One approach is to control bias power generator and MFC using OES signals from plasma to resolve the inconsistency problems with when bias voltage is applied during each RAP cycle and also to reduce fluctuation of spacing between scallops. FIG. 6 is a graphical representation 600 of various aspects of an OES signal, in accordance with an embodiment of the present invention. Any of d[F]/dt or d{[F]/[CF2]}/dt from the OES signal can be used as an accurate reference signal to trigger and control the timing of when the corresponding bias voltage is applied. [F]/[CF2] also can be used for this purpose, but using the derivatives d[F]/dt or d{[F]/[CF2]}/dt) is preferable because this signal is less sensitive to process change.

When the amplitude of d[F]/dt or d{[F]/[CF2]}/dt exceed a selected set point value, the bias voltage can be applied immediately. Alternatively, the when the amplitude of d[F]/dt or d{[F]/[CF2]}/dt exceed a selected set point value can be used to define more specific delay time for timing the application of the bias voltage and how long that bias voltage should be applied. In an exemplary case, a falling edge of the OES signal (e.g., negative value of derivative) can be used as triggering signal to change bias voltage applied back to the corresponding value.

Graph 602 illustrates the presence of a product of dissociation (e.g., F) of a second process gas (e.g., SF6) in the RAP chamber 110 as measured by a second intensity of an optical emission at a corresponding wavelength of light (e.g., F has a corresponding wavelength 704 nm). Graph 602 illustrates a ratio of the second intensity and the first intensity in the RAP chamber 110.

Graph 606 illustrates the derivative of the second intensity relative to time. Graph 608 illustrates the derivative of the ratio of the second intensity and the first intensity in the RAP chamber 110

This process control technique can be extended to any type of RAP plasma processes which use different gas chemistries. A small amount of noble gases can be added to a process gas mixture and emission lines of these species can be used in special cases. Emission intensity of these species can change even at a constant flow of noble gases due to change in electron energy distribution in the plasma which is result from RAP nature of the process.

To reduce fluctuation of spacing between scallops in the sidewalls of the device being formed and which are caused by fluctuation of gas delivery and duration of etch/passivation processes, the technique as described above can be used to control bias voltage. In this instance the system 100 determines the duration of the current etch phase. By way of example, an additional logical operation such as “or” and “and” for d[F]/dt and d{[F]/[CF2]}/dt ([F]/[CF2]) can be applied to achieve even more precise timing of the bias voltage application.

In this instance the proposed method suggested that gas delivery time from mass flow controller to the chamber should be less than: {[duration of etch phases]−[time required to find triggering signal]}.

The proposed technique reduces the time uncertainty when a specific bias voltage should be applied during RAP process cycle for optimum results. Application of alternative control of fast acting mass flow controller can further reduce variation of scallop size.

The above described process gases and the respective products of disassociation are used to exemplify the present invention, however it should be understood that other process gases and/or other products of disassociation of the above process gases can also or alternatively be used to detect the presence of the respective process gas in the RAP chamber 110. By way of example, CF is an alternative product of disassociation of C4F8. Further still, alternative process gases can be used which can be detected by the OES. The respective products of disassociation of the alternative process can be detected by the OES.

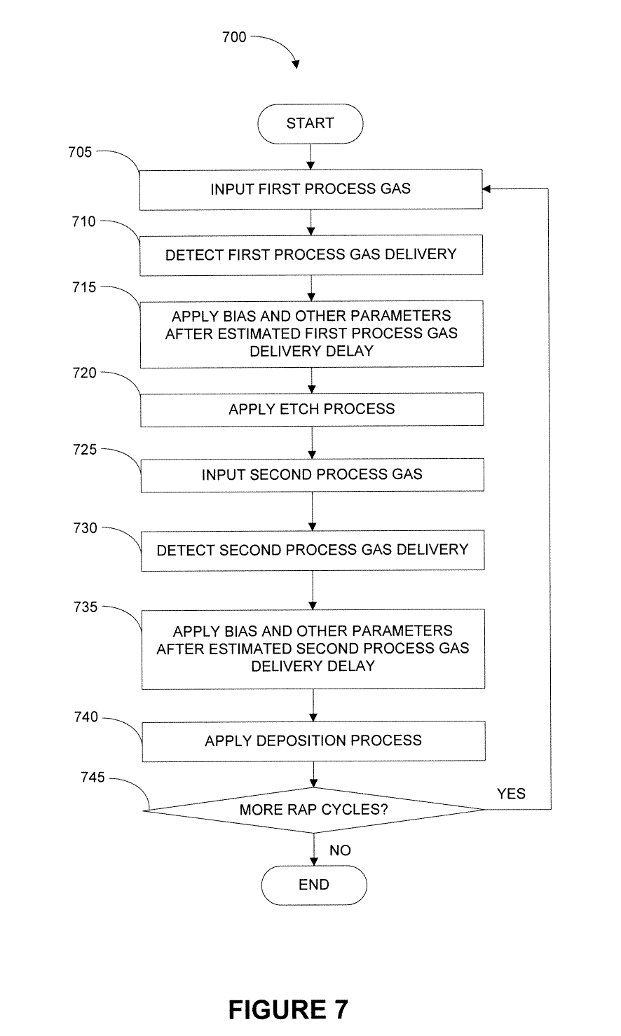

FIG. 7 is a flowchart diagram that illustrates the method and operations 700 performed in using an OES spectrum to control bias voltage, in accordance with one embodiment of the present invention. The operations illustrated herein are by way of example, as it should be understood that some operations may have sub-operations and in other instances, certain operations described herein may not be included in the illustrated operations. With this in mind, the method and operations 700 will now be described.

In operation 705, a first gas is input to the RAP chamber 110 including sending a first instruction from the controller 140 to the first mass flow controller 120 to flow the first gas from the first gas source 122.

In an operation 710, a first process gas delivery is detected by the OES analysis as described above. When the first process gas delivery is detected, the corresponding first process parameter set points 272 (e.g., first bias voltage, frequency, waveform, modulation, and power and the first plasma source power RF signal, voltage, frequency, waveform, modulation, and power of the signal used to generate the plasma 108 and other first process parameters) for the corresponding first phase, are applied to the RAP chamber 110, in an operation 715.

In an operation 720, the corresponding phase (e.g., an etch phase) is applied to the substrate 102 in the RAP chamber 110.

In operation 725, a second process gas is input to the RAP chamber 110 including sending a second instruction from the controller 140 to the second mass flow controller 130 to flow the second process gas from the second gas source 132.

In an operation 730, a second process gas delivery is detected by the OES analysis as described above. When the second process gas delivery is detected, the corresponding second process parameter set points 282 (e.g., second bias voltage, frequency, waveform, modulation, and power and the second plasma source power RF signal, voltage, frequency, waveform, modulation, and power of the signal used to generate the plasma 108 and other second process parameters) for the corresponding second phase, are applied to the RAP chamber 110, in an operation 735.

In an operation 740, the corresponding second phase (e.g., a deposition or passivation phase) is applied to the substrate 102 in the RAP chamber 110.

In an operation 745, an inquiry is made to determine if additional RAP cycles are necessary on the substrate 102 in the RAP chamber 110. If additional RAP cycles are necessary on the substrate 102 in the RAP chamber 110, the method operations continue in operation 705 as described above. The method operations can end if additional RAP cycles are not necessary on the substrate 102.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A rapid alternating process method comprising:
initiating a first rapid alternating process phase including:
inputting a first process gas into a rapid alternating process chamber;
detecting the first process gas in the rapid alternating process chamber, and
applying a corresponding first phase bias signal to the rapid alternating process chamber after the first process gas is detected in the rapid alternating process chamber.

2. The method of claim 1, wherein detecting the first process gas in the rapid alternating process chamber includes detecting a corresponding concentration of the first process gas in the rapid alternating process chamber.

3. The method of claim 1, wherein detecting the first process gas in the rapid alternating process chamber includes detecting a corresponding first product of disassociation of the first process gas.

4. The method of claim 1, wherein detecting the first process gas in the rapid alternating process chamber includes detecting a corresponding first optical emissions spectrum.

5. The method of claim 4, wherein detecting the corresponding first optical emissions spectrum includes determining a value of the detected corresponding first optical emissions spectrum.

6. The method of claim 5, wherein the corresponding first phase bias signal is applied to the rapid alternating process chamber when the determined value of the detected corresponding first optical emissions spectrum exceeds a preselected value.

7. The method of claim 5, wherein the determined value of the corresponding first optical emissions spectrum includes a derivative of the detected corresponding first optical emissions spectrum relative to time.

8. The method of claim 1, further comprising:
initiating a second rapid alternating process phase including:
inputting a process second gas into the rapid alternating process chamber;
detecting the second process gas in the rapid alternating process chamber; and
applying a corresponding second phase bias signal to the rapid alternating process chamber after the second process gas is detected in the rapid alternating process chamber.

9. The method of claim 8, further comprising:
determining if additional rapid alternating process cycles are required including:
ending the method if additional rapid alternating process cycles are not required; and
initiating the first rapid alternating process phase if additional rapid alternating process cycles are required.

10. The method of claim 1, wherein applying the corresponding first phase bias signal to the rapid alternating process chamber after the first process gas is detected in the rapid alternating process chamber includes applying at least one of a corresponding RF signal, voltage, frequency, waveform, modulation, and power of the first phase bias signal applied to the substrate or applying at least one of a corresponding RF signal, voltage, frequency, waveform, modulation, and power of the first plasma source power.

11. A rapid alternating process system comprising:
a rapid alternating process chamber;
a plurality of process gas sources coupled to the rapid alternating process chamber, wherein each one of the plurality of process gas sources includes a corresponding process gas source flow controller;
a bias signal source coupled to the rapid alternating process chamber;
a process gas detector coupled to the rapid alternating process chamber;
a rapid alternating process chamber controller coupled to the rapid alternating process chamber, the bias signal source, the process gas detector and the plurality of process gas sources, the rapid alternating process chamber controller including:
logic for initiating a first rapid alternating process phase including:
logic for inputting a first process gas into a rapid alternating process chamber;
logic for detecting the first process gas in the rapid alternating process chamber, and
logic for applying a corresponding first phase bias signal to the rapid alternating process chamber after the first process gas is detected in the rapid alternating process chamber.

12. The system of claim 11, wherein the logic for detecting the first process gas in the rapid alternating process chamber includes logic for detecting a corresponding concentration of the first process gas in the rapid alternating process chamber.

13. The system of claim 11, wherein the logic for detecting the first process gas in the rapid alternating process chamber includes logic for detecting a corresponding first product of disassociation of the first process gas.

14. The system of claim 11, wherein the logic for detecting the first process gas in the rapid alternating process chamber includes logic for detecting a corresponding first optical emissions spectrum by the process gas detector.

15. The system of claim 14, wherein the logic for detecting the corresponding first optical emissions spectrum includes logic for determining a value of the detected corresponding first optical emissions spectrum.

16. The system of claim 15, wherein the corresponding first phase bias signal is applied to the rapid alternating process chamber when the determined value of the detected corresponding first optical emissions spectrum exceeds a preselected value.

17. The system of claim 15, wherein the logic for determined value of the corresponding first optical emissions spectrum includes logic for determining a derivative of the detected corresponding first optical emissions spectrum relative to time.

18. The system of claim 11, wherein the rapid alternating process chamber controller further includes:
logic for initiating a second rapid alternating process phase including:
logic for inputting a process second gas into the rapid alternating process chamber;
logic for detecting the second process gas in the rapid alternating process chamber; and
logic for applying a corresponding second phase bias signal to the rapid alternating process chamber after the second process gas is detected in the rapid alternating process chamber.

19. The system of claim 18, wherein the rapid alternating process chamber controller further includes:
logic for determining if additional rapid alternating process cycles are required including:
logic for ending the method if additional rapid alternating process cycles are not required; and
logic for initiating the first rapid alternating process phase if additional rapid alternating process cycles are required.

20. A rapid alternating process system comprising:
a rapid alternating process chamber;
a plurality of process gas sources coupled to the rapid alternating process chamber, wherein each one of the plurality of process gas sources includes a corresponding process gas source flow controller;
a bias signal source coupled to the rapid alternating process chamber;
a process gas detector coupled to the rapid alternating process chamber;
a rapid alternating process chamber controller coupled to the rapid alternating process chamber, the bias signal source, the process gas detector and the plurality of process gas sources, the rapid alternating process chamber controller including:
logic for initiating a first rapid alternating process phase including:
logic for inputting a first process gas into a rapid alternating process chamber;
logic for detecting the first process gas in the rapid alternating process chamber including logic for detecting a corresponding first optical emissions spectrum by the process gas detector including logic for determining a value of the detected corresponding first optical emissions spectrum including logic for determining a derivative of the detected corresponding first optical emissions spectrum relative to time;
logic for applying a corresponding first phase bias signal to the rapid alternating process chamber after the first process gas is detected in the rapid alternating process chamber;
logic for initiating a second rapid alternating process phase; and
logic for determining if additional rapid alternating process cycles are required.
